(19) United States
(12) Patent Application Publication
(10) Pub. No.: US 2008/0223464 A1
(43) Pub. Date: Sep. 18, 2008

(54) Flow Diverters for Valves, Valves, and In-Floor Pool Cleaning Systems

(76) Inventor: Douglas E. Merrell, Gilbert, AZ (US)

Correspondence Address: WELLS ST. JOHN P.S., 601 W. FIRST AVENUE, SUITE 1300, SPOKANE, WA, 99201, US

(21) Appl. No.: 12/047,599

(22) Filed: Mar. 13, 2008

Related U.S. Application Data
(60) Provisional application No. 60/918,498, filed on Mar. 15, 2007.

(51) Int. Cl. A01G 25/16

(52) U.S. Cl. 137/625

(57) ABSTRACT

An in-floor pool cleaning system includes a first valve having one bottom inlet port, three or more side discharge ports, and a first flow diverter and a second valve having one bottom inlet port, three or more side discharge ports, and a second flow diverter. One of the discharge ports of the first valve is connected to the inlet port of the second valve. A first motor linked to the first valve is configured to rotate the first diverter and a second motor linked to the second valve is configured to rotate the second diverter. The system includes in-floor cleaning nozzles fluidically connected to discharge ports. A controller electrically connected to the motors is configured to actuate the motors and, in turn, to rotate the diverters into respective positions configured to direct water flow to a selected one or more of the plurality of nozzles.

### RELATED APPLICATION DATA

This patent claims the benefit of priority under 35 U.S.C. §119 to U.S. Provisional Application No. 60/918,498 filed Mar. 15, 2007, which is herein incorporated by reference.

### TECHNICAL FIELD

The invention pertains to flow diverters for valves, valves, and in-floor pool cleaning systems.

### BACKGROUND OF THE INVENTION

In-floor pool cleaning systems involve the distribution of water to in-floor cleaning nozzles, which generally rotate while injecting a flow of water to push accumulated debris on the pool bottom toward a floor drain or to suspend debris for removal by a surface skimmer or other collection system. A filter removes debris from the collected dirty water and a pool pump recirculates the filtered water back to the nozzles. The timing of water injections may be sequenced through selected cleaning zones to clean the entire pool bottom over time. U.S. Pat. No. 6,592,752 issued to Mathews describes one example of the various options available for in-floor pool cleaning systems and their operation.

Typically, water distribution mechanisms represent a central aspect of in-floor cleaning systems since they supply cleaning nozzles with the flow of water. Common distribution mechanisms involve passing water through a gear-box which rotates with the water flow, causing water to be delivered to selected cleaning nozzles. Unfortunately, water-driven gear-box systems produce water pressure losses, supplying cleaning nozzles with less pressure and, thus, with reduced cleaning ability. Gears in such systems also wear quickly and are often replaced within one to two years of installation.

Other fluid distribution valves, such as shown in U.S. Pat. No. 6,345,645 issued to Kenna, involve a rotating fluid distribution member driven by a motor and timer that lines up the fluid distribution member with selected fluid outlet openings. Such a mechanism resolves some of the pressure loss and maintenance concerns associated with water-driven gear-box systems. Nevertheless, the fluid distribution member resides in a large main housing, occupying a significant amount of space, which may not be readily available in proximity to some pools.

As a result, improvements may be warranted by providing water distribution mechanisms overcoming limitations of the known mechanisms described above.

### BRIEF DESCRIPTION OF THE DRAWINGS

Preferred embodiments of the invention are described below with reference to the following accompanying drawings.

FIG. 1 shows an exploded, perspective view of a valve.

FIG. 2 shows a perspective view of the valve in FIG. 1 with the valve stem not shown.

FIG. 3 shows a sectional, perspective view of the FIG. 1 valve taken along line 3-3.

FIGS. 4A and 4B show perspective views of a gasket configured for a gasket seat of the diverter shown in FIGS. 1-3 with the sectional view in FIG. 4B taken along line 4B-4B in FIG. 4A.

FIG. 5 shows a perspective view of a diverter alternative to that shown in FIGS. 1-3.

FIGS. 6A and 6B show perspective views of another diverter alternative to that shown in FIGS. 1-3.

FIGS. 7 and 8 show exploded, perspective views of valves analogous to that shown in FIGS. 1-3 with additional ports.

FIGS. 9 and 10 respectively show perspective and top views of three valves, such as shown in FIGS. 1-3, arranged in a cascade configuration.

FIG. 11 shows a sectional, perspective view of a valve alternative to that shown in FIG. 8.

FIG. 12 shows a perspective view of the diverter in the FIG. 11 valve.

FIG. 13 shows a perspective view of the gasket in the FIG. 11 valve.

FIG. 14 shows a perspective view of a gasket alternative to that shown in FIG. 13.

FIG. 15 shows a process flow diagram of an in-floor pool cleaning system.

### DETAILED DESCRIPTION OF THE PREFERRED EMBODIMENTS

To date, fluid distribution valves have been limited to supplying water flow at most to eight zones of cleaning nozzles. Even though individual zones may include multiple nozzles, valves described in the Background section may be inadequate to provide enough zones for some pools since the locations of cleaning nozzles associated with particular zones in the pool may warrant different timer settings for individual zones. Further, given the limitation in the number of cleaning zones, a separate valve and separate controls are often installed for distributing water to water features such as fountains, waterfalls, negative edges, etc. associated with a pool setting. Beyond the cost disadvantage of installing and maintaining additional water distribution mechanisms for the water features, the separate valve and controls may diminish water pressure available from the pool pump for the cleaning system unless synchronized to turn off during cleaning cycles. Consequently, an additional pump is often installed to service the water features.

In one aspect of the invention, an in-floor pool cleaning system includes a first valve having one bottom inlet port, three or more side discharge ports, and a first flow diverter and a second valve having one bottom inlet port, three or more side discharge ports, and a second flow diverter. One of the discharge ports of the first valve is fluidically connected to the inlet port of the second valve. By fluidically connecting one of the discharge ports of the first valve to the inlet port of the second valve, the two valves are placed in a cascade configuration. That is, the flow from a discharge port of the first valve may be selected to cascade downstream to the second valve.

The in-floor pool cleaning system may be enabled to take advantage of the cascade configuration by including a first motor linked to the first valve and configured to rotate the first diverter and a second motor linked to the second valve and configured to rotate the second diverter. The system includes a plurality of in-floor cleaning nozzles with individual nozzles fluidically connected to at least one of the discharge ports of the first valve and/or second valve. A controller electrically connected to the motors is configured to actuate the motors and, in turn, to rotate the diverters into respective positions configured to direct water flow to a selected one or more of the plurality of nozzles.

By way of example, a variety of options exist in fluidically connecting individual nozzles to at least one of the discharge ports of the first valve and/or second valve. That is, only one individual nozzle might be fluidically connected to two or more discharge ports of the first valve and/or second valve. Consequently, the one individual nozzle may receive water flow from either of the discharge ports to which it is fluidically connected. Alternatively, more than one individual nozzle may receive water flow from only one of the discharge ports. In this manner, one cleaning zone using multiple nozzles may receive water flow from only one of the discharge ports. Also alternatively, an arrangement of fluidic connections is conceivable whereby more than one individual nozzle may receive water flow from two or more discharge ports of the first valve and/or second valve. Such an arrangement allows one cleaning zone using multiple nozzles to receive water flow from either of the discharge ports.

The various fluidic connections may be accomplished using known pipe, tubing, hoses, etc. along with known connectors such as tee's, Y's, manifolds, etc. Any known material(s) may be used for the connections.

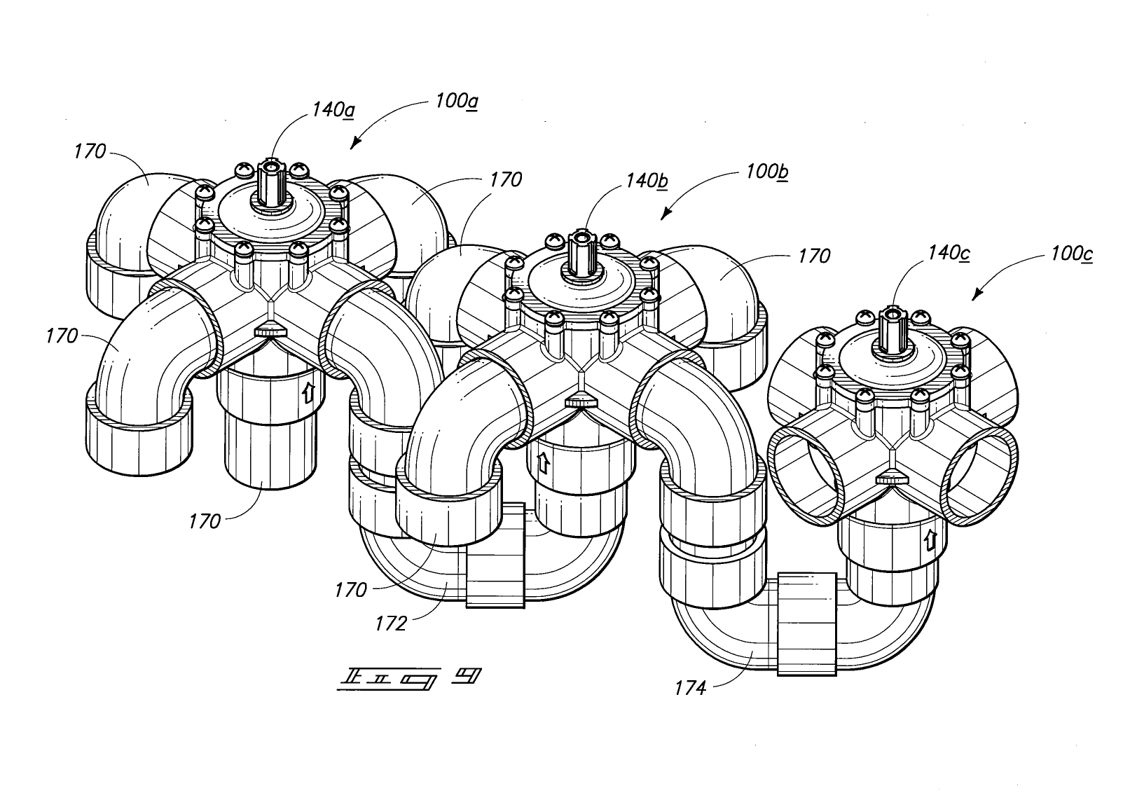

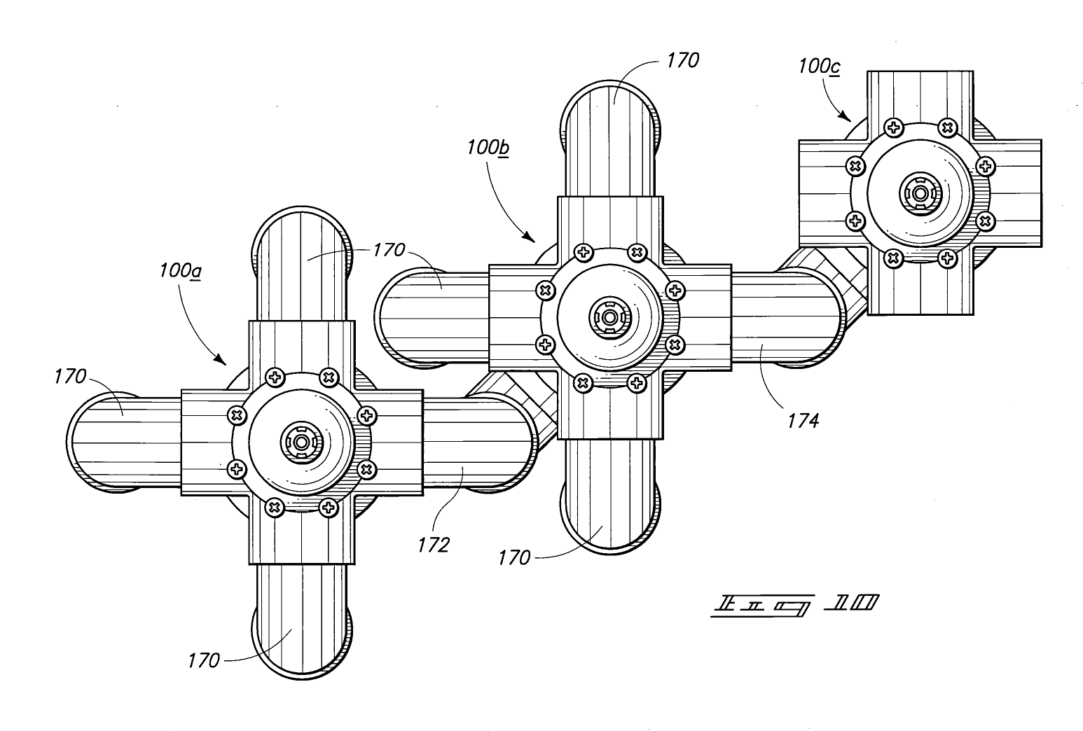

FIGS. 9 and 10 show a cascade configuration including valve 100a, valve 100b, and valve 100c. Piping 170 is shown fluidically connected to inlet and discharge ports of the valves. Piping 170 may in turn be fluidically connected to nozzles (not shown) of an in-floor pool cleaning system. Some or all of piping 170 might instead be fluidically connected to water features (not shown), such as fountains, waterfalls, negative edges, etc. Cascade piping 172 fluidically connects a discharge port of valve 100a to the inlet port of valve 100b. Likewise, cascade piping 174 fluidically connects a discharge port of valve 100b to the inlet port of valve 100c.

Even though FIGS. 9 and 10 show only one valve connected by its inlet port to one discharge port of an upstream valve, it is conceivable that a tee or Y in cascade piping 172 or 174 might enable more than one valve to be fluidically connected to the discharge port of valve 100a and/or 100b. In this manner, a wide variety of configurations are conceivable, which may include valves connected in series as shown in FIGS. 9 and 10, in parallel, or both.

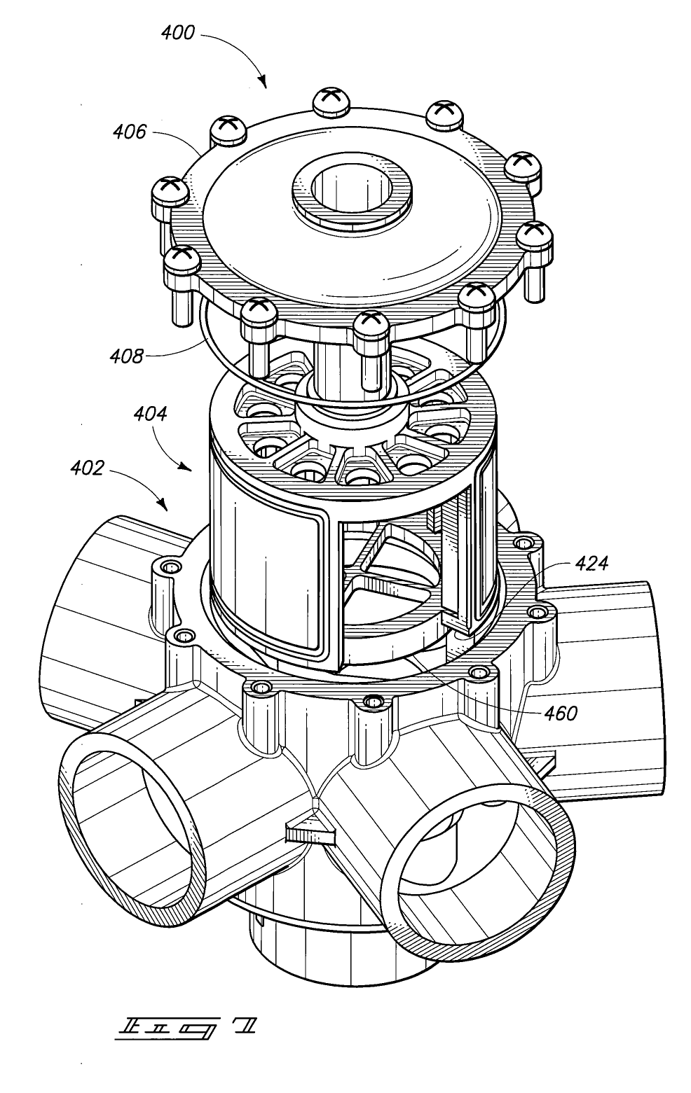

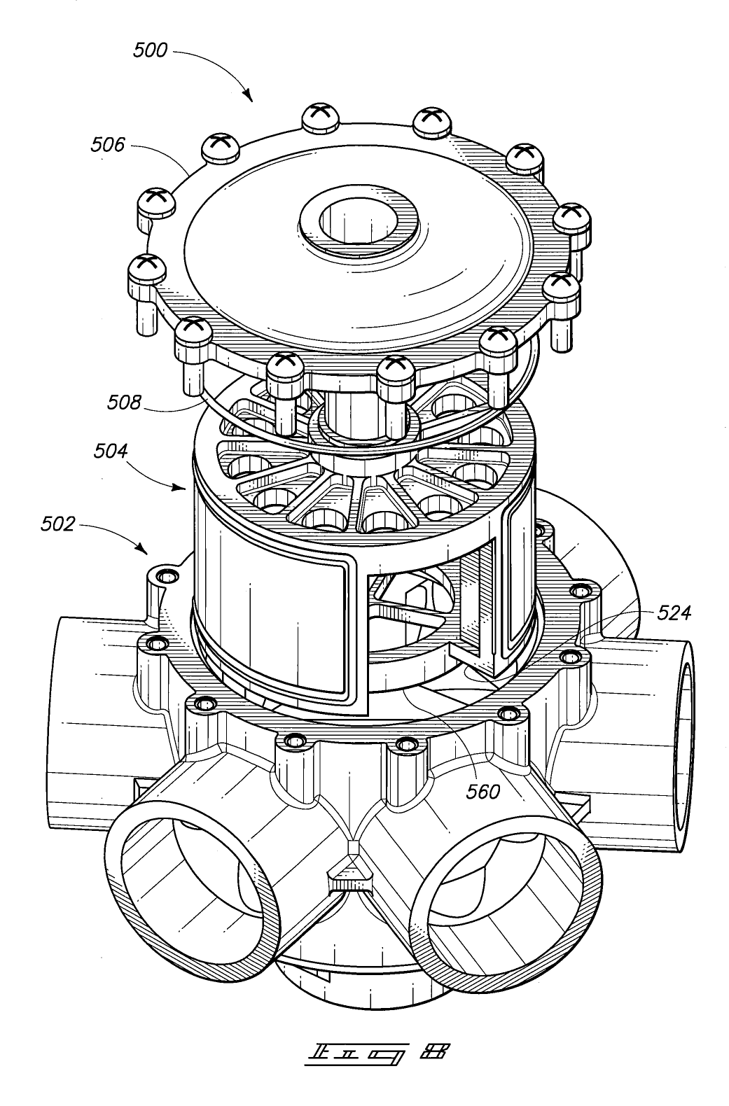

Notably, the combination of the three 4-port valves shown in FIGS. 9 and 10 provides 10 discharge ports for directing water flow to nozzles of an in-floor pool cleaning system, to water features, or to elsewhere. If three 5-port valves, such as shown in FIG. 7, were used, then the combination would provide 13 discharge ports. Similarly, a combination of three 6-port valves, such as shown in FIG. 8, would provide 16 discharge ports.

Water flow may be directed to 3 of the discharge ports on valve 100a by rotating its diverter into respective positions associated with the desired discharge port. Water flow may be directed to 3 of the discharge ports on valve 100b by rotating the valve 100a diverter to the discharge port fluidically connected with the inlet port of valve 100b and rotating the valve 100b diverter into respective positions associated with the desired discharge port of valve 100b. Water flow may be directed to 4 of the discharge ports on valve 100c by rotating the valve 100a diverter to the discharge port fluidically connected with the inlet port of valve 100b, rotating the diverter of valve 100b to the discharge port fluidically connected with the inlet port of valve 100c, and rotating the valve 100c diverter into respective positions associated with the desired discharge port of valve 100c.

Various combinations of 3-port, 4-port, 5-port, or 6-port (or more ports) valves are conceivable to adapt any valve configuration to the particular needs of an in-floor pool cleaning system, along with associated water features where desirable. A significant amount of flexibility exists in a cascade configuration of valves with valve selection customized to the needs of a particular application. A single, large valve with a large number of ports is comparable inflexible. The large number of ports may be too many ports for some applications, creating additional expense without justification, or may be too few ports, limiting the options available for the number and placement of nozzles and/or water features.

As will be appreciated further from the discussion below, valves 100a, 100b, and 100c include respective stems 140a, 140b, and 140c used to link the valves to respective motors (not shown), which rotate flow diverters inside the valves. Any known motor capable of appropriately rotating to the diverters into respective positions configured to direct water flow for accomplishing the purposes of the in-floor pool cleaning system may be used.

Similarly, any known controller capable of appropriately actuating the motors to accomplish the indicated rotation may be used. For the configuration of FIGS. 9 and 10, directing water flow to one of the valve 100c discharge ports involves controlling not only valve 100c, but also valves 100a and 100b to cascade water flow through the proper discharge ports to downstream inlet ports.

Controllers capable of independent time settings for each discharge port provide the advantage of increased flexibility in setting cleaning time and duration (or, similarly, cleaning start and stop time) for particular nozzle locations. Some nozzle locations may warrant longer cleaning times in comparison to other nozzle locations, depending primarily upon the pool surface area they are intended to clean.

Controllers with on-demand, single button settings for certain discharge ports may allow users to activate a water feature on the push of a button without a separate controller and/or pump dedicated for water features. Also, like nozzle locations, water features may be scheduled to activate at a selected time for a desired duration (or until a desired stop time).

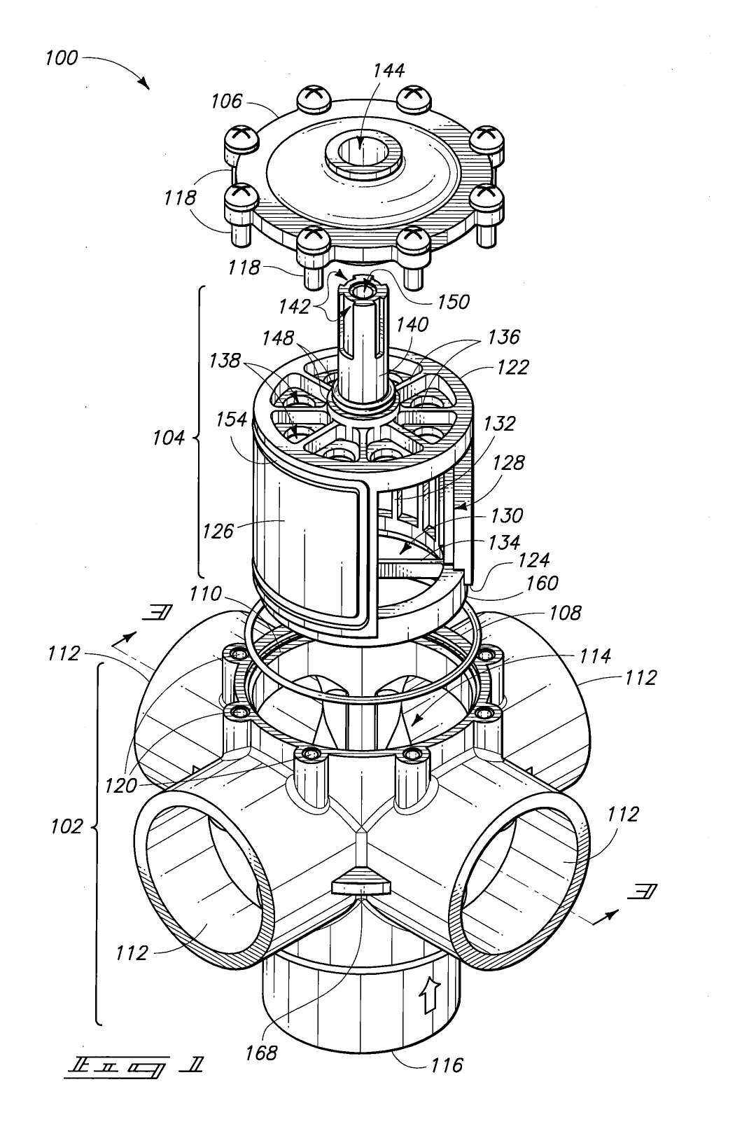

While a variety of valves might be suitable for use in a cascade configuration, such as the configuration of FIGS. 9 and 10, the valves shown in FIGS. 1-3, 7, 8, and 11 and analogous 3-port valves are particularly suitable and the valve of FIGS. 1-3 is used in the configuration of FIGS. 9 and 10. However, one or more of the valves according to any of the aspects of the inventions described herein might also be combined with one or more known valves.

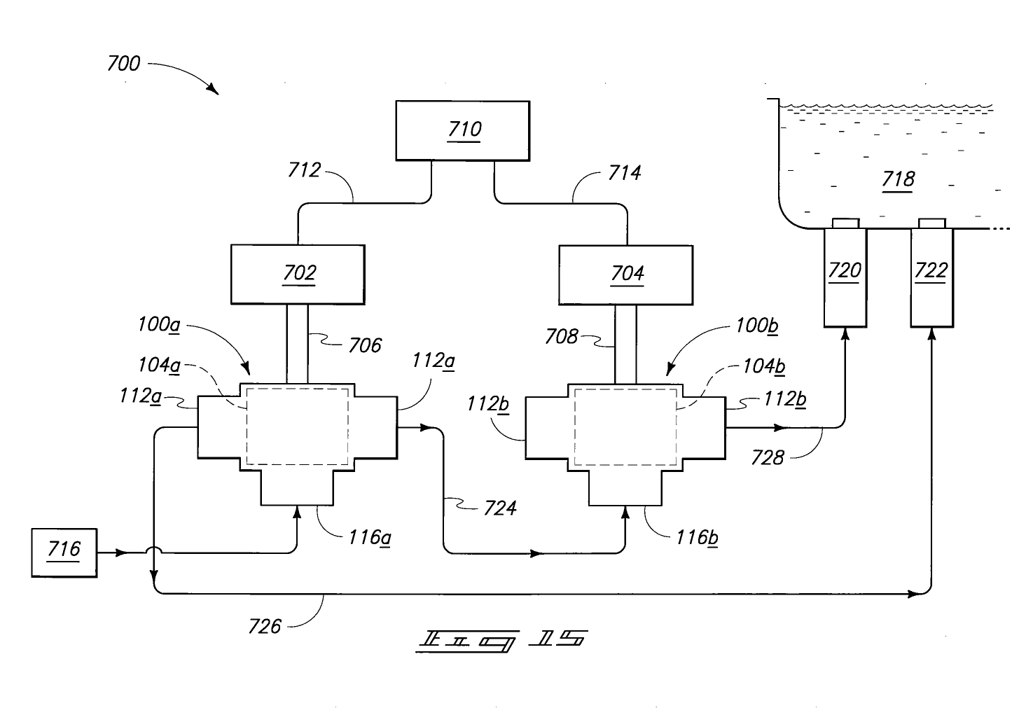

FIG. 15 includes valve 100a and valve 100b from FIGS. 9 and 10 but, for simplicity, leaves out possible additional valves. Different valves, including those described herein as well as others, having three or more side discharge ports may be substituted for valves 100a and/or 100b. A water supply 716 provides water flow to a bottom port 116a of valve 100a. Water supply 716 may be provided from a pool pump recirculating water from a pool 718 through cleaning system 700. However, other sources, such as a domestic water supply, are conceivable.

Using a diverter 104a, water flow may be distributed in valve 100a to any one of side ports 112a. For simplicity, the process flow diagram of FIG. 15 only shows two of the four side ports for each of valve 100a and valve 100b. One of side ports 112a may provide water flow to bottom port 116b of valve 100b via a fluidic connection 724. Using a diverter 104b, water flow may in turn be distributed in valve 100b to any one of side ports 112b. One of side ports 112a may provide water flow to an in-floor cleaning nozzle 722 in pool 718 via a fluidic connection 726. One of side ports 112b may provide water flow to an in-floor cleaning nozzle 720 also in pool 718 via a fluidic connection 728. Nozzle 722 may provide water flow for cleaning of a first zone of pool 718 while nozzle 720 provides water flow for cleaning of a second zone of pool 718.

A motor 702 and a motor 704 are mechanically linked with valves 100a and 100b via a link 706 and a link 708, respectively. Links 706 and 708 may comprise and/or utilize features of stems 140, 340, and 640 described in the accompanying Figures. A controller 710 is connected with motor 702 and motor 704 via an electrical connection 712 and an electrical connection 714, respectively. Motor 702 is configured to rotate diverter 104a and motor 704 is configured to rotate diverter 104b. Controller 710 is configured to independently actuate motor 702 and motor 704 and, in turn, to rotate diverter 104a and diverter 104b into respective positions configured to direct water flow to nozzle 720 or nozzle 722. Consequently, cleaning system 700 may be used to clean pool 718.

In another aspect of the invention, a valve includes a valve body and a flow diverter. The valve body includes one bottom port, three or more side ports, and a cylindrical recess for the flow diverter. The flow diverter is in the diverter recess. The diverter has a side face defined by more than two-thirds of a side surface of a corresponding right-angle cylinder. The valve includes a passageway through the diverter from a bottom end of the diverter to the side face. The bottom end corresponds to a base of the right-angle cylinder and the passageway is configured to orient flow through the valve from the bottom port to any one of the side ports aligned with the passageway.

In a further aspect of the invention, a valve includes a valve body, a flow diverter, and a seal between the diverter and the body. The valve body includes one bottom port, three or more side ports, and a cylindrical recess for the flow diverter. The flow diverter is in the diverter recess. The diverter has a cylindrical outer shape including a circular bottom end, a circular top end opposing the bottom end, and a side face between the bottom and top ends. A passageway is inside the outer shape. The diverter includes a bottom opening through the bottom end into the passageway and a side opening from the passageway through the side face. The bottom opening is associated with the bottom port and the side opening is selectively associated with any one of the side ports. The seal between the diverter and the body is configured to isolate the one of the side ports from all other of the side ports at least when the side opening is symmetrically aligned with the one of the side ports.

By way of example, the diverter may further include a valve stem at the top end. The side opening may have opposing edges and the seal may be a continuous gasket extending at least partially around the side face adjacent the top end, down the side face adjacent both of the opposing edges of the side opening, and at least partially around the side face adjacent the bottom end. The seal may include at least a rectangular portion wrapped partially around the side face and inserted in a corresponding continuous gasket seat in the side face. Excluding the side opening, the side face may include more than two-thirds of a side surface of a corresponding right-angle cylinder. Trim openings may be provided. Thus, a top trim opening from the passageway through the top end may be included. In addition or instead, a trim opening from the passageway through the bottom end may be included.

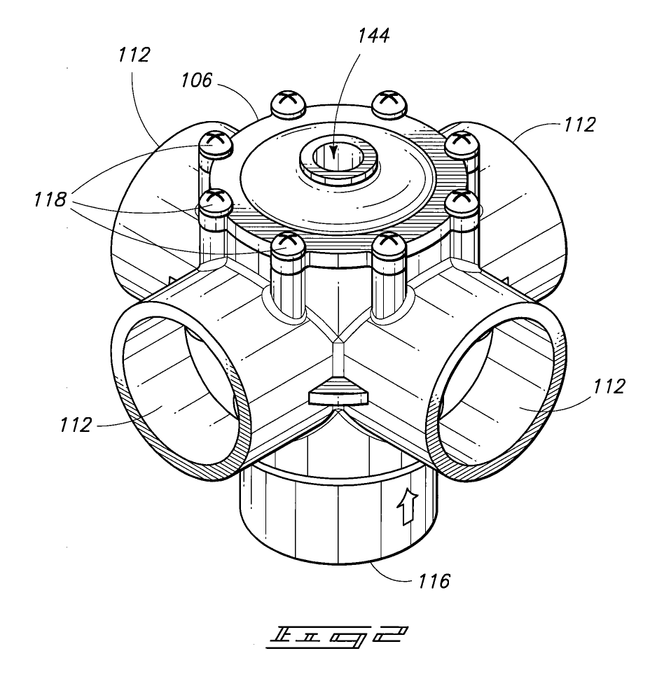

FIGS. 1-3 show various views of a valve 100 that includes a body 102 and a diverter 104. FIG. 1 provides an exploded view with diverter 104 removed from recess 114. The same valve is shown assembled in FIG. 2, except that a stem 140 is not shown. A lid 106 is aligned with body 102 such that bolts 118 may be tightened into holes 120, securing lid 106 in place. Stem 140 extends through opening 144 in lid 106. Stem 140 includes notches 142 for forming a mechanical link with a motor (not shown) configured to rotate diverter 104. Notches 142 may correspond with like ridges in the link to avoid slippage. Depending on the type of link, a hole 150 provides for insertion of a securing bolt or some portion of the link.

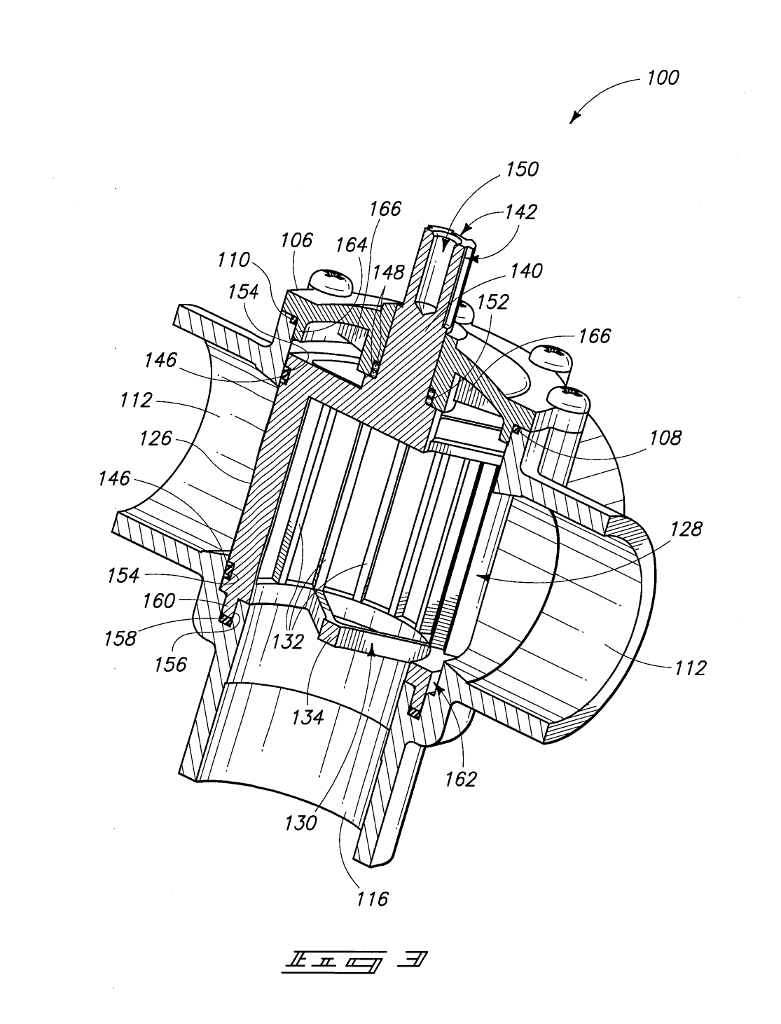

A gasket 108 fits within a seat 110 so that lid 106 may seal water inside body 102. FIG. 3 shows that lid 106 includes a lip 164, which participates in sealing the contents of valve 100 and retaining gasket 108 in seat 110. Sealing the contents of body 102 inside valve 100 also involves the use of gaskets 148 around stem 140. FIG. 3 shows a seat 152 in lid 106 to receive and retain gaskets 148 in place and thus maintain a water-tight seal even though stem 140 extends through opening 144.

Body 102 includes a bottom port 116 and four side ports 112 allowing passage of water through valve 100. Although four side ports are shown in the Figures, three to six, or even more, ports may be provided while maintaining consistency with the design principles and features described herein. Port supports 168 are provided on the valve exterior for reinforcement between side ports 112. Side ports 112 may be sized with an inside diameter matching fluidic connections for a particular application. Although the valve shown in FIGS. 1-3 is designed for inserting a pipe inside side ports 112 and bottom port 116, known design specifications may be incorporated to accommodate alternative fluidic connections such as tubing, hose, etc.

Diverter 104 has a top end 122, a bottom end 124, and a side face 126 extending between top end 122 and bottom end 124. A side opening 128 is provided through side face 126 allowing entry into or exit out of the interior of diverter 104. With consideration of side face 126 as being a cylindrical, it becomes apparent that, excluding side opening 128, side face 126 includes more than two-thirds of a side surface of a corresponding right-angle cylinder. Bottom end 124 thus corresponds to a base of the right-angle cylinder. A bottom opening 130 through bottom end 124 also provides entry into or exit out of the interior of diverter 104. When assembled with body 102, bottom opening 130 corresponds with bottom port 116 and diverter 104 may be rotated into a position such that side opening 128 corresponds with any one of side ports 112. In this manner, a passageway is provided through the diverter from bottom end 124 to side face 126. The passageway is thus configured to orient flow through valve 100 from bottom port 116 to any one of side ports 112 aligned with side opening 128.

Although the discussion herein primarily refers to water flow from bottom port 116 to side ports 112, fluids other than water may be accommodated in valve 100 and other valves discussed herein. Also, the direction of flow may be from side ports 112 to bottom port 116 instead of the opposite direction.

Diverter 104 includes several features making its use particularly advantageous. A lip 160 extends from bottom end 124 and is configured in diameter and lip width to correspond with a seat 156 in body 102. A gasket 158 placed in the bottom of seat 156 may assist with enhancing the ease with which diverter 104 may be rotated within body 102. Consequently, tolerances associated with matching lip 160 to seat 156 and gasket 158 are not so much intended to provide a sealing arrangement as to provide a low friction arrangement. Polytetrafluoroethylene (PTFE) gasket materials (which may be sold under the trademark TEFLON) constitute one example of materials believed suitable to provide a low friction arrangement in seat 156.

Another feature of diverter 104 includes trim openings which enhance distribution of pressure-generated forces within valve 100 so as to avoid distortion of diverter 104, yielding pinching or binding during water flow. Top supports 136 provided at top end 122 provide reinforcement of top end 122 despite the presence of trim openings 138 from inside diverter 104 through top end 122. Consequently, trim openings 138 allow entry of water into a space between diverter 104 and lid 106. With the equalization of water pressure inside and above diverter 104, underside supports 166 are provided for lid 106 to assist in withstanding the pressure. In similar fashion, side supports 132 and bottom supports 134 are provided for diverter 104. In addition to the trim openings discussed herein, side supports 132, bottom supports 134, top supports 136, and underside supports 166 assist with reducing distortion that might result in pinching or binding of the structures or breakthrough of water past gasket 108 and/or gaskets 148.

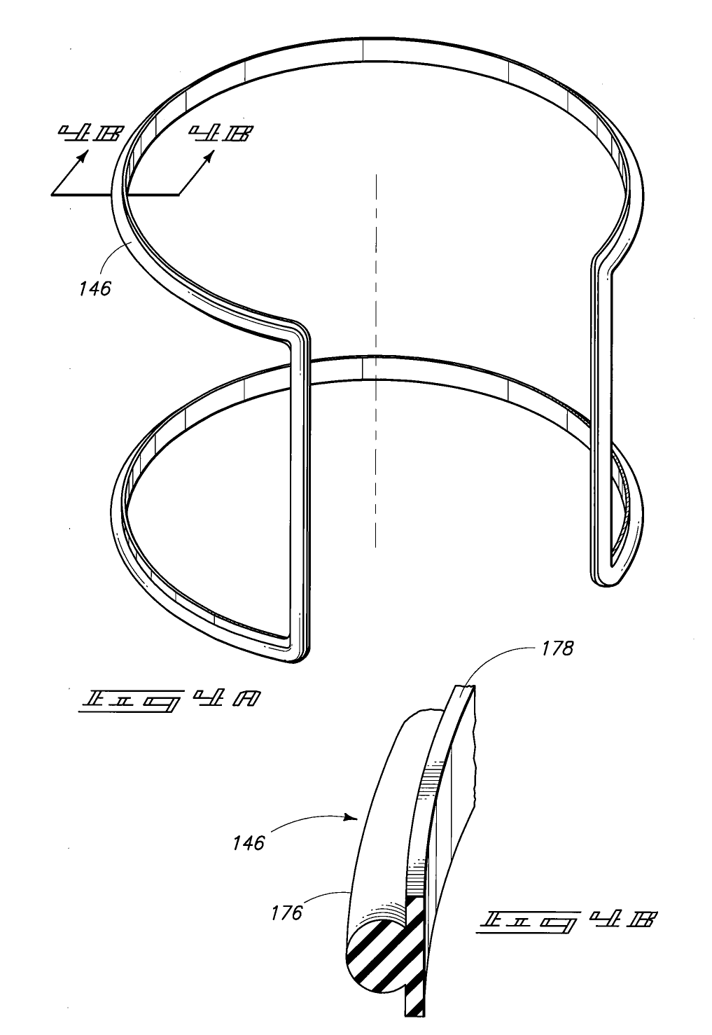

A further feature of diverter 104 includes a gasket configured to isolate one of side ports 112 from all other of side ports 112 at least when side opening 128 is symmetrically aligned with the one of side ports 112. Gasket 146, which appears in FIG. 3 and is shown alone in further detail in FIGS. 4A and 4B, represents one example of a gasket configured to isolate one of side ports 112. Gasket 146 is continuous, has a rectangular shape, and is wrapped partially around side face 126. More specifically, gasket 146 has a flat inner portion 178 and a rounded outer portion 176. Inner portion 178 may be inserted in a corresponding continuous seat 154 extending partially around side face 126. Gasket 146 is not shown in FIG. 1 in order to reveal therein the structure of seat 154.

Notably, side opening 128 of diverter 104 has opposing edges extending vertically and seat 154 extends partially around side face 126 adjacent top end 122, down side face 126 adjacent both of the opposing edges of side opening 128, and partially around side face 126 adjacent bottom end 124. The opposing edges shown are parallel, but may be shaped differently. As one example, other forms of symmetric edges may provide a side opening with a shape other than shown, such as circular or elliptical. Since inner portion 178 of gasket 146 is inserted in seat 154, gasket 146 is retained in place throughout rotation of diverter 104 and may seal one of side ports 112 from any other of side ports 112 when side opening 128 is appropriately positioned. Outer portion 176 of gasket 146 functions as a typical O-ring in maintaining the seal. Gasket 146 may accomplish the sealing even though trim openings 138 allow passage of water above diverter 104.

FIG. 3 shows a trim opening 162, allowing further equalization of water pressure below diverter 104. As also shown in FIG. 1, trim opening 162 is continuous with side opening 128. That is, they form two parts of a single opening even though side opening 128 extends through side face 126 but trim opening 162 extends through bottom end 124. Conceivably, side opening 128 and trim opening 162 could be separated such that trim opening 162 extended through bottom end 124 at a location not continuous with side opening 128. However, the combined openings simplify design of diverter 104.

Essentially, as shown in FIG. 3, trim opening 162 provides a significant gap between diverter 104 and body 102 directly below side opening 128. As such, water pressure may equalize around bottom end 124 and lip 160 of diverter 104 in a similar fashion to that described for trim openings 138 through top end 122.

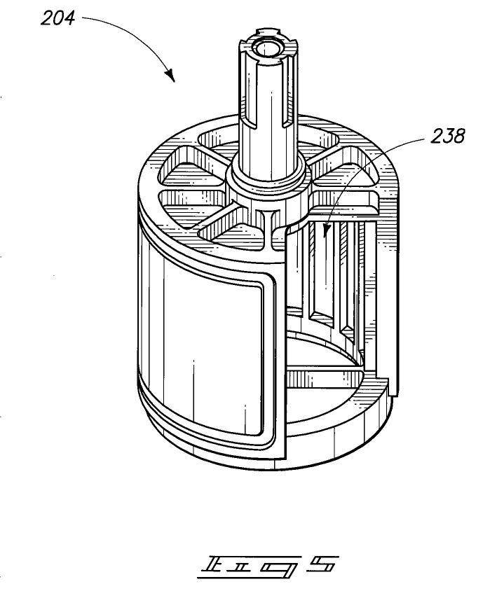

FIG. 5 shows a diverter 204 that includes a variation in design compared to diverter 104. Specifically, diverter 204 does not include trim openings 138 through top end 122. Instead, diverter 204 includes a single trim opening 238. Otherwise, diverter 104 and diverter 204 are identical. The primary difference between trim openings 138 and trim opening 238 is that trim openings 138 are separate from side opening 128 instead of combined therewith as for trim opening 238. Upon consideration of trim opening 162 as well, it becomes apparent that the alternative shown in FIG. 5 combines top and bottom trim openings with a side opening as three parts of a single opening. Depending upon the pressures to which diverter 104 and 204 may be subjected, it is conceivable that one diverter may perform differently than the other. Engineering analysis may be completed to discover any performance differences.

In a still further aspect of the invention, a flow diverter for a valve includes a cylindrical outer shape having a circular bottom end, a circular top end opposing the bottom end, and a side face between the bottom and top ends. The diverter includes a passageway inside the outer shape, an inlet opening through the bottom end into the passageway and a discharge opening from the passageway through the side face. The discharge opening has opposing edges. A continuous gasket seat extends at least partially around the side face adjacent the top end, down the side face adjacent both of the opposing edges of the discharge opening, and at least partially around the side face adjacent the bottom end. The diverters in FIGS. 1, 3, 5, 7, 8, 11, and 12 provide examples of such diverters. Notably, the various features discussed above for diverters may be incorporated into this aspect of the invention.

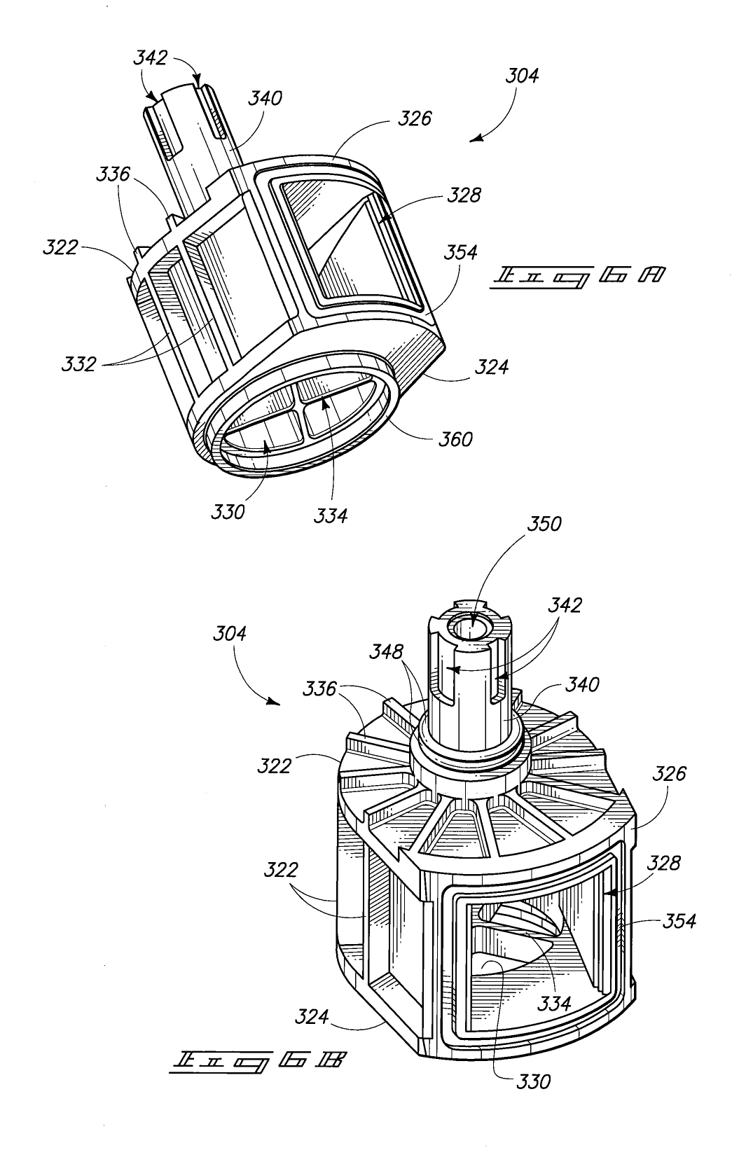

FIGS. 6A and 6B show a diverter 304 including significant differences compared to diverters 104 and 204, despite some similarities. Diverter 304 includes a top end 322, a bottom end 324, and a side face 326 extending between top end 322 and bottom end 324. A side opening 328 is provided through a side face 326, allowing entry into or exit out of the interior of diverter 304. A bottom opening 330 through bottom end 324 also provides entry into or exit out of the interior of diverter 304. Bottom opening 330 may correspond with a bottom port of a valve body analogous to valve bodies in the Figures. Diverter 304 may be rotated into a position such that side opening 328 corresponds with any one of a plurality of side ports of such a body. In this manner, a passageway is provided through diverter 304 from bottom end 324 to side face 326. The passageway is thus configured to orient flow through a valve using diverter 304 from a bottom port to any one of multiple side ports.

Bottom supports 334, top supports 336, and side supports 332 of diverter 304 assist with reducing distortion that might result in pinching or binding of structures in a valve using diverter 304. The contents of such a valve may be sealed inside with the use of gaskets 348 around a stem 340 even though stem 340 extends through an opening in a lid analogous to the lids in the Figures. Notches 342 and a hole 350 allow for mechanical linking with a motor.

Diverter 304 may be further configured so that it may be accommodated in valves such as shown in the Figures. Side face 326 may include a portion of a side surface of a corresponding right-angle cylinder. Clearly, such a side face includes far less of a side surface of a right-angle cylinder in comparison to diverters 104 and 204. Also, a seat 354 may accommodate a gasket (not shown) analogous to a gasket 146 that similarly includes a flat inner portion and a rounded outer portion. Of course, a gasket for seat 354 may be sized quite differently in comparison to gasket 146 so as to correspond with seat 354.

A lip 360 of diverter 304 may be sized so that a seat, such as seat 156 of body 102 may accommodate lip 360. The distance from lip 160 to side face 126 compared to the distance from lip 360 to side face 326 represents one difference between diverter 104 and diverter 304. Such distance may be selected so that diverter 304 may be accommodated within a selected valve body. Alternatively, the dimensions of a valve body may be selected to be different from those shown in the Figures so as to accommodate diverter 304.

The absence of trim openings represents another difference between diverter 104 and diverter 304. The design of diverter 304 precludes the presence of trim openings. If trim openings are provided, then diverter 304 does not include any structural features to isolate one of the side ports from all other of the side ports. Such difference constitutes one advantage of diverter 104 over diverter 304 since trim openings allow further equalization of forces generated by operational pressures in the valve. Consequently, even though lid 106 may be used to seal valve 100, little, if any, advantage is obtained from such sealing in the absence of a diverter design with trim openings to equalize internal forces and structural features isolating a selected side port from the other side ports.

FIG. 7 shows a valve 400 that includes five ports, but provides essentially the same structural features in comparison to valve 100. A valve body 402 is expanded in diameter to accommodate another side port and a diverter 404 is similarly increased in diameter to correspond with body 402. A lid 406 is likewise increased in diameter along with a gasket 408. However, in the alternative shown in FIG. 7, a lip 460 extending from a bottom end 424 maintains like dimensions in comparison with valve 100. Maintaining dimensions of lip 460 results in diverter 404 extending further radially from lip 460 in comparison to a distance that diverter 104 extends radially from lip 160 to side face 126. It is conceivable that, instead of maintaining lip dimensions in lip 460, such dimensions could be altered in valve 400.

FIG. 8 shows a valve 500 that includes six ports, but provides essentially the same structural features in comparison to valve 400. A valve body 502 is expanded in diameter to accommodate another side port and a diverter 504 is similarly increased in diameter to correspond with body 502. A lid 506 is likewise increased in diameter along with a gasket 508. Port supports 580 are provided on the valve exterior for reinforcement between a bottom port 516 and the expanded diameter of valve body 502 and are similar in structure and function to port supports 568. In the alternative shown in FIG. 8, a lip 560 extending from a bottom end 524 maintains like dimensions in comparison with valve 400 (as well as valve 100). Maintaining dimensions of lip 560 results in diverter 504 extending further radially from lip 560 in comparison to a distance that diverter 404 extends radially from lip 460. It is conceivable that, instead of maintaining dimensions of lip 560, such dimensions could be altered in valve 500.

Notably, diverter 304 shown in FIGS. 6A and 6B extends a distance from lip 360 to side face 326 that matches the radial extension distance of diverter 504 from lip 560. Consequently, diverter 504 and diverter 304 are interchangeable in the sense that both may be used in body 502. However, diverter 504 exhibits several advantages over diverter 304, as discussed above in the context of similar diverter 104.

Although the diameters of diverters 404 and 104 are smaller in comparison to the diameter of diverter 504, it is conceivable that three-port, four-port, and five-port valves may be based upon the valve 500 six-port design merely by leaving off three, two, or one port, respectively. Such designs might simplify manufacturing and maintenance since the lids, gaskets, and diverters could exhibit common size and material specifications among the three to six-port valves and only the valve bodies could differ. Interchangeable parts may allow maintenance personnel to maintain a smaller inventory of parts, reducing overhead costs. Understandably, diverter 304 may also be interchangeable in the three-port to five-port valve designs.

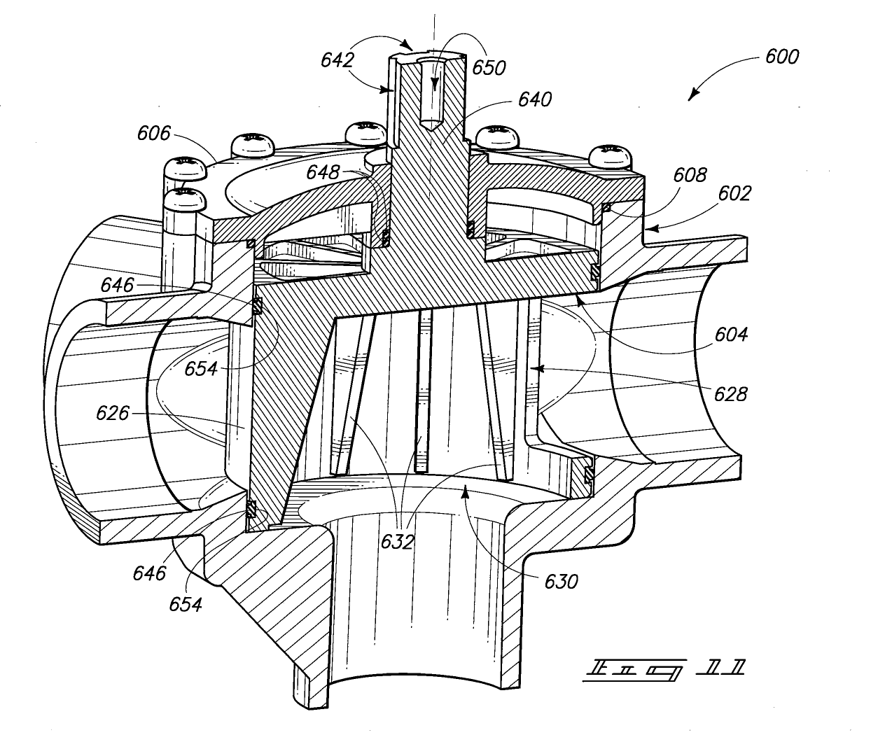

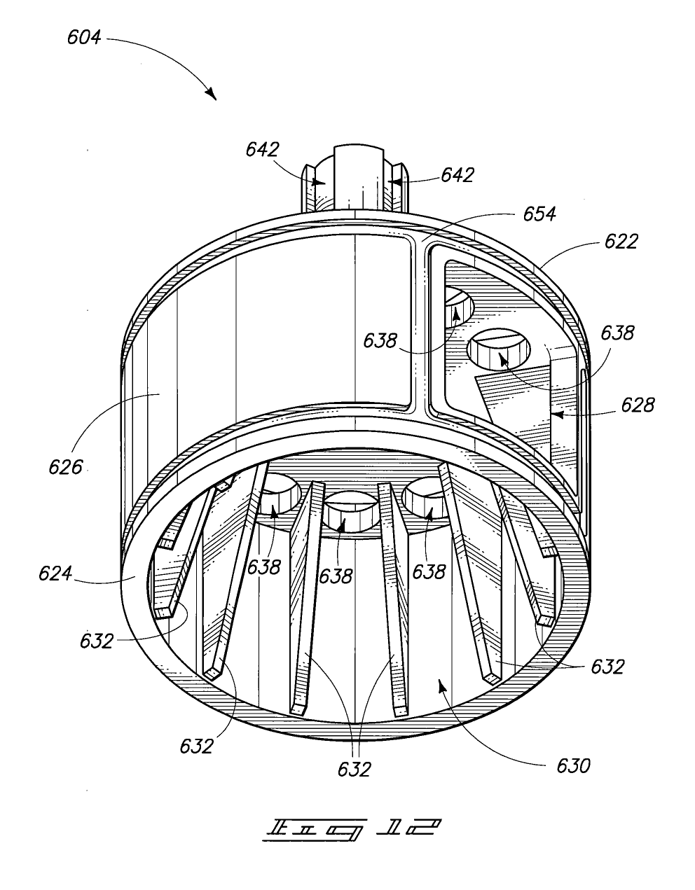

FIG. 11 shows a valve 600 with numerous similarities, but a few significant differences, that may be compared and contrasted with valves 100, 400, and 500 and the variations therein discussed above. FIG. 11 primarily represents a cross sectional view of valve 500 along a plane of symmetry, but including a flow diverter 604 different from diverter 504 in valve 500. FIG. 12 shows further detail of diverter 604. Although other diverters described herein perform their intended functions and include unique features of themselves, differences in diverter 604 represent design changes resulting from engineering analysis of diverter 504 (and analogous diverters) to address possible distortion from operation pressures. Further advantages of diverter 604 are described below.

Valve 600 includes a valve body 602, which is for the most part identical to body 502 of six-port valve 500. The absence of a seat (such as seat 156 of valve 100) in body 602 to receive a lip (such as lip 560 of diverter 504) represents the difference between body 602 and body 502. Since diverter 604 does not include a lip, no seat in body 602 is present to receive the lip. However, it should be appreciated that body 602 may include such a seat so that diverter 504 and diverter 604 are interchangeable within body 602. Presence of a seat might not interfere with proper operation of diverter 604. Body 602 includes port supports 680 analogous to port supports 580 and are shown in FIG. 11 with additional detail. Other components of valve 600 analogous with like components of valves 100, 400, and 500 include a lid 606, a gasket 608, and gaskets 648 along with their related structures in body 602.

Stem 640 of diverter 604 includes notches 642 for forming a mechanical link with a motor (not shown) configured to rotate diverter 604. Notches 642 may correspond with like ridges in the link to avoid slippage. Depending on the type of link, a hole 650 provides for insertion of a securing bolt or some portion of the link.

Diverter 604 has a top end 622, a bottom end 624, and a side face 626 extending between top end 622 and bottom end 624. A side opening 628 is provided through side face 626 allowing entry into or exit out of the interior of diverter 604. With consideration of side face 626 as being a cylindrical, it becomes apparent that, excluding side opening 628, side face 626 includes more than two-thirds of a side surface of a corresponding right-angle cylinder. In fact, side face 626 includes more than three-fourths of a side surface of a corresponding right-angle cylinder since diverter 604 is configured for a six-port valve. Bottom end 624 corresponds to a base of the right-angle cylinder.

A bottom opening 630 through bottom end 624 also provides entry into or exit out of the interior of diverter 604. When assembled with body 602, bottom opening 630 corresponds with the bottom port and diverter 604 may be rotated into a position such that side opening 628 corresponds with any one of the side ports. In this manner, a passageway is provided through the diverter from bottom end 624 to side face 626. The passageway is thus configured to orient flow through valve 600 from the bottom port to any one of the side ports aligned with side opening 628.

Although the discussion herein primarily refers to water flow from the bottom port to the side ports, fluids other than water may be accommodated in valve 600 and other valves discussed herein. Also, the direction of flow may be from the side ports to the bottom port instead of the opposite direction.

Diverter 604 includes several features making its use particularly advantageous. Notably, diverter 604 does not include a lip extending from bottom end 624 in a manner analogous to lip 160. Although lip 160 is designed to have a low friction arrangement with seat 156, removal of lip 160 further reduces friction. Other design changes discussed below enable removal of lip 160.

Diverter 604 includes trim openings which enhance distribution of pressure-generated forces within valve 600 so as to avoid distortion of diverter 604, yielding pinching or binding during water flow. Top supports provided at top end 622 are the same as in diverter 504 (and analogous with top supports 136 of diverter 104) and provide reinforcement of top end 622 despite the presence of trim openings 638 from inside diverter 604 through top end 622. Consequently, trim openings 638 allow entry of water into a space between diverter 604 and lid 606.

With the equalization of water pressure inside and above diverter 604, underside supports such as underside supports 166 are provided for lid 606 as in lid 106 of valve 100 to assist in withstanding the pressure. In similar fashion, side supports 632 are provided for diverter 604, but bottom supports, such as bottom supports 134 of valve 100 are removed. Other design changes discussed below enable removal of bottom supports 134. In addition to the trim openings discussed herein, side supports 632, top supports, and underside supports assist with reducing distortion that might result in pinching or binding of the structures or breakthrough of water past gasket 608 and/or gaskets 648.

Notably, the shape of side supports 632 differs from the shape of side supports 132. Side supports 632 include a triangular, instead of rectangular, profile readily apparent from FIG. 12. That is, the top of side supports 632 attached to top end 622 of diverter 604 is longer along a radial direction than the bottom of side supports 632 adjacent bottom end 624. The radial direction intersects with a readily apparent rotational axis of diverter 604. By comparison, the top and bottom of side supports 132 have the same length along a radial direction. The triangular profile of side supports 632 increases the strength of side face 626 at and near bottom end 624, allowing elimination of bottom supports 134 and lip 160.

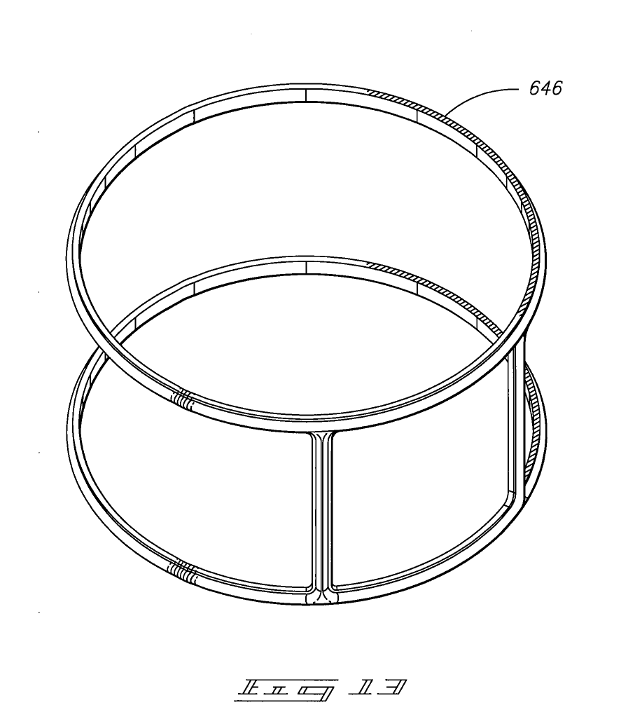

Diverter 604 includes a gasket configured to isolate one of the side ports from all other of the side ports at least when side opening 628 is symmetrically aligned with the one of the side ports. Gasket 646, which appears alone in FIG. 13, represents one example of a gasket configured to isolate one of the side ports. Gasket 646 may have the same cross-sectional shape as gasket 146 shown in FIG. 4B. Gasket 646 is continuous and has at least a rectangular portion wrapped partially around side face 626. Gasket 646 is inserted in a corresponding continuous seat 654 extending at least partially around side face 626. Gasket 646 is not shown in FIG. 12 in order to reveal therein the structure of seat 654. In particular, seat 654 extends completely around side face 626 adjacent top end 622 and completely around side face 626 adjacent bottom end 624. Gasket 646 corresponds with seat 654.

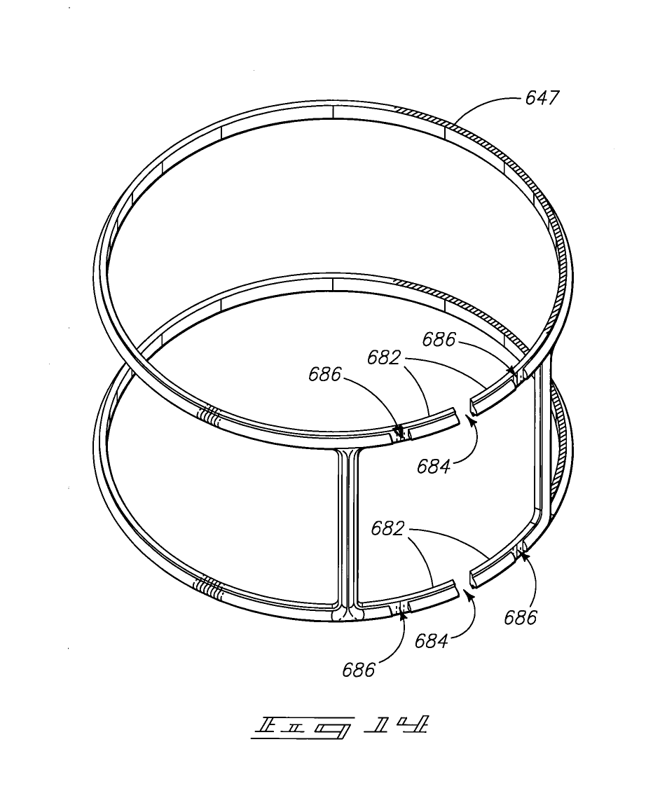

FIG. 14 shows an alternative gasket 647, which does not extend completely around side face 626 like gasket 646. Instead, gasket 647 includes gasket projections 682 extending across side face 626 above side opening 628 and below side opening 628. Gaps 684 exist between opposing dead ends of projections 682. Projections 682 are continuous with the remainder of gasket 647.

It will be appreciated that gasket 647 may be placed in seat 654 even though it does not correspond with seat 654. Alternatively, seat 654 may be modified to correspond with gasket 647. That is, the portion of seat 654 extending across side face 626 above and below opening 628 may instead include seat projections (not shown) corresponding with projections 682 of gasket 647. In such case, gasket 646 will not correspond with the modified seat. However, both gasket 647 and gasket 646 are considered to include at least a rectangular portion wrapped partially around side face 626. Gasket 647 further includes trim openings 686 through the rounded outer portion of the gasket material, but not through the flat inner portion (see discussion of gasket material structure pertaining to FIGS. 4A and 4B above).

Notably, side opening 628 of diverter 604 has opposing edges extending vertically and seat 654 additionally extends down side face 626 adjacent both of the opposing edges of side opening 628. The opposing edges shown are parallel, but may be shaped differently. As one example, other forms of symmetric edges may provide a side opening with a shape other than shown, such as circular or elliptical. Since an inner portion of gasket 646 is inserted in seat 654, gasket 646 is retained in place throughout rotation of diverter 604 and may seal one of the side ports from any other of the side ports when side opening 628 is appropriately positioned. An outer portion of gasket 646 functions as a typical O-ring in maintaining the seal. Gasket 646 may accomplish the sealing even though trim openings 638 allow passage of water above diverter 604. Gasket 647 also accomplishes the sealing even though trim openings 686 and gaps 684 allow passage of water from side opening 628 above and below diverter 604. Engineering analysis and/or pilot testing may be used to determine whether gasket 646 exhibits advantages over gasket 647 or vice versa.

As indicated in the Background, some in-floor pool cleaning systems use water-driven gear-box systems. Typically, gear-box systems provide 5 or 6 ports. As a result, a further advantage of the aspects of the inventions herein includes the five and six-port valves being amenable to direct retrofitting of existing gear-box systems. Retrofitting may increase water flow and decrease repair costs.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A flow diverter for a valve comprising:
a cylindrical outer shape including a circular bottom end, a circular top end opposing the bottom end, and a side face between the bottom and top ends;
a passageway inside the outer shape;
an inlet opening through the bottom end into the passageway and a discharge opening from the passageway through the side face, the discharge opening having opposing edges;
a continuous gasket seat extending at least partially around the side face adjacent the top end, down the side face adjacent both of the opposing edges of the discharge opening, and at least partially around the side face adjacent the bottom end.

2. The diverter of claim 1 wherein the diverter further comprises a valve stem at the top end.

3. The diverter of claim 1 wherein the gasket seat extends completely around the side face adjacent the top end and completely around the side face adjacent the bottom end.

4. The diverter of claim 1 wherein the gasket seat further comprises seat projections extending across the side face above the discharge opening and below the discharge opening.

5. The diverter of claim 1 further comprising a corresponding gasket in the gasket seat.

6. The diverter of claim 5 wherein the gasket comprises at least a rectangular portion wrapped partially around the side face.

7. The diverter of claim 1 further comprising a top trim opening from the passageway through the top end.

8. The diverter of claim 7 wherein the top trim opening and the discharge opening are separate.

9. The diverter of claim 1 wherein, excluding the discharge opening, the side face comprises more than two-thirds of a side surface of a corresponding right-angle cylinder.

10. A valve comprising:
a valve body including one bottom port, three or more side ports, and a cylindrical recess for a flow diverter;
a flow diverter in the diverter recess, the diverter having a side face defined by more than two-thirds of a side surface of a corresponding right-angle cylinder; and
a passageway through the diverter from a bottom end of the diverter to the side face, the bottom end corresponding to a base of the right-angle cylinder and the passageway being configured to orient flow through the valve from the bottom port to any one of the side ports aligned with the passageway.

11. A valve comprising:
a valve body including one bottom port, three or more side ports, and a cylindrical recess for a flow diverter;
a flow diverter in the diverter recess, the diverter having a cylindrical outer shape including a circular bottom end, a circular top end opposing the bottom end, and a side face between the bottom and top ends;
a passageway inside the outer shape;
a bottom opening through the bottom end into the passageway and a side opening from the passageway through the side face, the bottom opening being associated with the bottom port and the side opening being selectively associated with any one of the side ports;
a seal between the diverter and the body, the seal being configured to isolate the one of the side ports from all other of the side ports at least when the side opening is symmetrically aligned with the one of the side ports.

12. The valve of claim 11 wherein the side opening has opposing edges and the seal comprises a continuous gasket extending at least partially around the side face adjacent the top end, down the side face adjacent both of the opposing edges of the side opening, and at least partially around the side face adjacent the bottom end.

13. The valve of claim 11 wherein the diverter further comprises a valve stem at the top end.

14. The valve of claim 11 wherein the seal comprises at least a rectangular portion wrapped partially around the side face and inserted in a corresponding continuous gasket seat in the side face.

15. The valve of claim 11 further comprising a top trim opening from the passageway through the top end.

16. The valve of claim 11 wherein, excluding the side opening, the side face comprises more than two-thirds of a side surface of a corresponding right-angle cylinder.

17. An in-floor pool cleaning system comprising:
a first valve including one bottom inlet port, three or more side discharge ports, and a first flow diverter;
a second valve including one bottom inlet port, three or more side discharge ports, and a second flow diverter, one of the discharge ports of the first valve being fluidically connected to the inlet port of the second valve;
a first motor linked to the first valve and configured to rotate the first diverter;
a second motor linked to the second valve and configured to rotate the second diverter;
a plurality of in-floor cleaning nozzles, individual nozzles being fluidically connected to at least one of the discharge ports of the first valve and/or second valve; and
a controller electrically connected to the motors, the controller being configured to actuate the motors and, in turn, to rotate the diverters into respective positions configured to direct water flow to a selected one or more of the plurality of nozzles.

18. The system of claim 17 wherein the first diverter comprises:
a cylindrical outer shape including a circular bottom end, a circular top end opposing the bottom end, and a side face between the bottom and top ends;
a passageway inside the outer shape;
an inlet opening through the bottom end into the passageway and a discharge opening from the passageway through the side face, the discharge opening having opposing edges;
a continuous gasket extending at least partially around the side face adjacent the top end, down the side face adjacent both of the opposing edges of the discharge opening, and at least partially around the side face adjacent the bottom end.

19. The system of claim 17 wherein the first valve comprises:
a valve body including the inlet port, the discharge ports, and a cylindrical recess for the flow diverter;
the flow diverter in the diverter recess, the diverter having a side face defined by more than two-thirds of a side surface of a corresponding right-angle cylinder; and
a passageway through the diverter from a bottom end of the diverter to the side face, the bottom end corresponding to a base of the right-angle cylinder and the passageway being configured to orient flow through the valve from the inlet port to any one of the discharge ports aligned with the passageway.

20. The system of claim 17 wherein the first valve comprises:
a valve body including the inlet port, the discharge ports, and a cylindrical recess for the flow diverter;
a flow diverter in the diverter recess, the diverter having a cylindrical outer shape including a circular bottom end, a circular top end opposing the bottom end, and a side face between the bottom and top ends;
a passageway inside the outer shape;
a bottom opening through the bottom end into the passageway and a side opening from the passageway through the side face, the bottom opening being associated with the inlet port and the side opening being selectively associated with any one of the discharge ports;
a seal between the diverter and the body, the seal being configured to isolate the one of the discharge ports from all other of the discharge ports at least when the side opening is symmetrically aligned with the one of the discharge ports.
